(19) United States
(12) Patent Application Publication
(10) Pub. No.: US 2011/0014107 A1
(43) Pub. Date: Jan. 20, 2011

(54) Process For Preparing Anhydrous Rare Earth Metal Halides

(76) Inventors: Ganesh Gurpur Pai, Mumbai (IN); Ajay Anant Audi, Mumbai (IN); Ramchandran Velayudaan Nair, Mumbai (IN); Nagaraj Ramappa Bhagoji, Mumbai (IN)

Correspondence Address: BRINKS HOFER GILSON & LIONE, P.O. BOX 10395, CHICAGO, IL, 60610, US

(21) Appl. No.: 12/865,115

(22) PCT Filed: Dec. 24, 2008
(86) PCT No.: PCT/IN2008/000862

§ 371 Date: Jul. 28, 2010

(30) Foreign Application Priority Data
Sep. 17, 2008 (IN) 1977/MUM/2008

(51) Int. Cl. C01F 17/00

(52) U.S. Cl. 423/263

(57) ABSTRACT

Processes of preparing anhydrous rare earth metal halides are provided. In some embodiments, the rare earth metal halide is cerium (III) chloride. In other embodiments, the rare earth metal halide is lanthanum chloride.

### PRIORITY

This application claims priority to PCT/IN/2008/000863, filed Dec. 24, 2008 and Indian patent application 1977/MUM/2008, filed Sep. 17, 2008. The disclosures of the priority applications are incorporated by reference herein in their entirety.

### FIELD OF INVENTION

The present invention relates to a novel process of preparing anhydrous rare earth metal halides from their hydrates. More particularly the present invention relates to a method of preparing anhydrous cerium (III) chloride comprising a novel method of dehydration of cerium (III) chloride heptahydrate.

### BACKGROUND OF THE INVENTION

Rare earth metal halides generally occur in nature in hydrated form and comprise a number of molecules of water, typically 3 to 9 per molecule of halide. Anhydrous rare earth halides have very wide range of applications such as chemical or electrochemical reduction process for the production of metal, reduction of organometralics to carbonyl compounds and the like. The structural water of the rare earth metal halide hydrates interferes and adversely impacts the yield and purity of the corresponding desired product. It is difficult to remove the total water of hydration at ambient temperature from the hydrated salts of the respective rare earth metal halide as at higher temperatures rare earth metal halides form the corresponding oxy halides. These rare earth metal oxy halide impurity formed during the preparation of anhydrous rare earth metal halide from their corresponding hydrated salts by traditional methods reported in the prior art, restrict their use in chemical reactions such as catalyst in the addition of organometalics to carbonyl group to form the corresponding alcohols and the like.

To overcome the afore cited limitations in the prior art to prepare anhydrous rare earth metal halides disclosed herein is a novel method of preparing anhydrous rare earth metal halides comprising an efficient and economical method of removing water of hydration from the corresponding hydrated rare earth metal halides avoiding formation of rare earth metal oxy halide. The term anhydrous rare earth metal halide hereinabove and hereinbelow mean rare earth metal halides conforming to commercial grade of anhydrous rare earth metal halide that is technically suitable for use in applications requiring use of anhydrous rare earth metal halides such as catalyst for Grignard reaction and the like.

J. Inorg. Nucl. Chem., 5 (1957), 118 discloses the thermal decomposition of hydrated rare-earth chlorides to obtain monohydrate. However, removal of the last molecule of water requires heating to temperature above 200° C. The process of heating at high temperature results in the formation of corresponding oxy halides as an impurity. The presence of the said oxyhalide as an impurity makes the anhydrous rare earth metal halide unsuitable for applications wherein anhydrous metal halide is used such as its use as a catalyst in Grignard reaction and the like.

Gmelin Handbook (1982), part C4a, Chapt. 11.2.6 describes dehydrating processes employing dehydrating agents such as hydrogen halides, ammonium halides, carbon tetrachloride, phosgene or thionyl chloride, as well as halogens. C.R. Accord. Sci. 134 (1902), 427 and Kleinheksel and Kremers (JACS, 50, (1928), 959 describes passing of dehydrating agent over the hydrated halide. However, the said prior art processes give a mixture of anhydrous rare earth metal halides and corresponding oxy halides, therefore, are not efficient and economical at an industrial scale.

WO97/07057 discloses a method of reduction of rare earth metal oxy halide present as impurity in anhydrous rare earth metal halide formed during the dehydration of corresponding rare earth metal halide hydrate comprising direct chlorination of rare earth metal oxy chloride by reaction with carbon and chlorine. However, this method is connected with the release of environmentally unacceptable chlorinated hydrocarbons. Furthermore, high temperature used (1100-1200° C.) in the process causes the corrosion of reactor material resulting in the lower purity of the product.

Planinsel et al, The rare earth in Modern Science and Technology, ed. by McCarthy et al, Vol. 2 (1980) reports the direct conversion of the rare earth oxide by reaction with ammonium chloride. This process requires a large amount of over stoichiometric ammonium chloride to achieve conversion degrees over 97%. It is necessary to remove excess of ammonium chloride and this can be achieved by sublimation in vacuum. This method is inefficient with respect to time and product purity.

EP0395472 discloses a process for the dehydration of rare earth metal halides comprising purging mixture of dry air, hydrogen chloride and chlorine gas through a packed bed of rare earth chlorides. This is a batch process requiring significant amounts of chlorinating agent and is a long time process.

WO97/07057 discloses a method for producing anhydrous rare earth metal chlorides by dehydration of hydrated rare earth chlorides by the continuous or batch-wise feeding of hydrated rare earth chlorides in a fluidized bed system comprising one reactor or several reactors coupled in series; introducing dry gas composed of air, air/hydrogen chloride, nitrogen/hydrogen chloride, inert gas/hydrogen chloride or pure hydrogen chloride at an elevated temperature.

The expression “Rare earths” employed in accordance with the invention hereinbefore and hereinafter includes the rare earth elements called lanthanides having atomic numbers from 57-71 and also inclusive of yttrium of atomic number 39. The invention applies to all the halides of said elements, especially to the halides of lanthanum, neodymium, cerium, and praseodymium, yttrium, and gadolinium, more especially the halides of cerium and lanthanum excluding fluorides and most especially to cerium chloride.

CN 101037216, Crystal Growth & Design (2006), 6(4), 809-811, Rengong Jingti Xuebao (2006), 35(4), 686-691. Prior art describes the preparation of anhydrous lanthanum chloride comprising non vacuum drying of lanthanum chloride heptahydrate which comprises heating of lanthanum chloride heptahydrate in hydrogen chloride atmosphere at 200-300° C.

Prior art discloses that the preparation of anhydrous cerium chloride comprising vacuum drying of cerium chloride heptahydrate for 2 hrs at 60° C. followed by for 2 hrs at 80° C. and continuing for 12 hrs at 140° C. results in the formation of lump, therefore, inefficient at industrial scale.

Organic syntheses, Coll. Vol, 10, p 200 (2004); Vol. 76, p 228 (1999) describes evacuation of powdered cerium (III) chloride heptahydrate to 0.1-0.2 mm. After gradual warming to 90° C. over 30 minutes on an oil bath followed by heating at 90-100° C. for two hrs with intermittent heating. Powder is again pulverized and reheated to 90° C. at 0.1-0.2 mm over 30 minutes, followed by further evacuation at 90-100° C. for 1.5 hrs. This entire process produces cerium (III) chloride monohydrate. The monohydrate so obtained is then gradually warmed to 140° C. under 0.1-0.2 mm for 30 minutes without stirring. Heating at 140-150° C./0.1-0.2 mm for two hrs with gentle stirring affords a fine powder of anhydrous cerium chloride.

CN1785814 discloses a method of anhydrous cerium chloride by using excess ammonium chloride. The process comprises heating the mixture of ammonium chloride and cerium chloride at 120-370° C. and 0.05-0.095 MPa resulting into anhydrous cerium chloride whose water content is less than 2.0%.

U.S. Pat. No. 2,982,603 describes a process for preparing anhydrous cerium chloride from a hydrated oxalate of cerium by saturating with hydrogen chloride.

CN 101037216 discloses a process for preparing anhydrous lanthanum chloride comprising calcination and dehydration in dry hydrogen chloride atmosphere.

EP1053974 describes a method of drying of Lewis acids like zinc bromide, zinc chloride, zinc iodide, other metal salt, or mixtures thereof by the azeotropic distillation. It particularly discloses recovery of Lewis acid from the reaction as an aqueous solution and further drying by azeotropic distillation. It does not describe removal of water of crystallisation from a compound.

U.S. Pat. No. 3,352,634 discloses azeotropic drying of magnesium chloride salts, wherein magnesium chloride is in conjunction with magnesium chloride solvent and an entraining solvent characterized in that the magnesium chloride is not soluble therein forms an azeotropic mixture. Moreover it also comprises precipitation of magnesium chloride as its ammoniate followed by decomplexation. Here, magnesium chloride solvent means a solvent in which the salt is soluble (e.g. isoamyl alcohol or hexyl alcohol).

Prior art does not provide an efficient, economical and industrially viable process for making pure anhydrous rare earth metal halides.

The present invention relates to preparation of anhydrous rare earth metal halides conforming to commercial grade anhydrous rare earth metal halides by the dehydration of corresponding hydrated rare earth metal halides. Invention does not apply to rare earth metal fluorides, which do not contain any water of hydration.

Reaction of organometallics to carbonyl compounds to yield corresponding alcohols are undoubtedly one of the most fundamental and versatile reaction in organic chemistry and has wide spread synthetic applications.

It is also well known that the addition of organometallics like Grignard reaction to carbonyl compounds is often accompanied by abnormal reactions such as reduction, enolisation, condensation, conjugate addition and pinacol coupling. In some cases such abnormal reactions prevail over the normal reaction resulting into poor yields of the desired product.

The application of anhydrous CeCl₃ for the preparation of organocerium (III) reagents for addition reactions to carbonyl compounds has been one of the most important synthetic methods developed in recent years. The presence of anhydrous cerium chloride has been found to promote the addition reaction with remarkable suppression of abnormal reaction products occurring due to enolisation. Using this concept it has been possible to make various tertiary alcohols, which are difficult to prepare by the conventional Grignard reaction (Pure & Appl. Chem., vol 62, No. 4, pp 747-752, 1990) and (Adv. Synth. Catal. 2004, 346, 1307-1315). However, the success of this reaction depends solely on the moisture content of CeCl₃. Tetrahedron letters, Vol. 37, No 37, 1996 pp 6787-6790 discloses that activity and efficiency mainly depends on moisture content of cerium chloride. Deactivation of CeCl₃ occurs during the drying process as a result of formation of cerium oxy chloride when heated above 90° C. Thus for the success of the addition of organometallics depends strongly on the activity of cerium chloride irrespectively of the addition procedure used and the solubility of the catalyst. The difficulty phased in such reaction is mainly the drying of cerium chloride as it occurs as heptahydrate.

Adv. Synth. Cata 1.2004, 346, 1307-1315 describes a detailed study for making (S)-hydroxy esters with Grignard reagent in presence of cerium chloride having variable moisture contents. This paper describes tray drying accomplished through stepwise heating up at a vacuum level of 50 mm Hg with nitrogen sweep through the drier. The temperature ramp was 80° C. for 8 hrs followed by 140° C. for 35 hrs. Stepwise heat up is necessary due to significant initial water removal rate furnishing partially dried material which is then further dried in a rotary drier having vacuum level of 50 mm Hg, a jacket temperature of 140° C. and a rotational speed of 2 rpm.

The application of anhydrous LaCl₃ for silylation has been one of the most important synthetic methods developed in recent years.

Prior art discloses methods of forming anhydrous rare earth metal halides such as cerium chloride and lanthanum chloride by techniques such as vacuum dehydration; chemical drying e.g. with chlorinating agent, physical drying techniques such as prevaporisation, spray drying, nonvacuum drying in a environment of a drying agent at high temperature. Prior art methods suffer from one or other following disadvantages:
1) Use of chlorinating agent
2) High temperature requirement
3) Release of environmentally unacceptable chlorinated hydrocarbons.
4) Sublimation of excessive ammonium chloride
5) Time consumption is more.
6) Need of solvent in which salt is soluble
7) Complexation with ammonia thereby introducing additional step
8) Decomplexation of ammoniate, an additional unit operation
9) Formation of corresponding rare earth metal oxy halides which acts as impurity that adversely impact the activity of rare earth metal halide as a catalyst in the chemical reaction particularly for the addition of organometalics to carbonyl function.
10) Lump formation during vacuum drying making it rock hard and difficult for crushing.
11) Vacuum drying causes a lot of corrosion of the dryers used for the purpose.

Considering prior art limitations for the preparation of anhydrous rare earth metal halides there is a need for an efficient, economical and industrially viable process for the preparation of anhydrous rare earth metal halides on industrial scale with consistent reproducible results. One potential concern during the thermal dehydration is the stability of rare earth metal halides. It is known that these halides degrades to give HCl and form corresponding oxychloride product in the presence of water at high temperature. Thus there is a requirement for an economical and industrially viable process for the preparation of anhydrous rare earth metal halides preferably cerium chloride and lanthanum chloride and more preferably cerium chloride.

The present invention relates to a novel process for the preparation of anhydrous rare earth halides that can overcome all the disadvantages cited in the prior art. The present invention discloses a novel process for preparing anhydrous rare earth metal halides which does not require use of chlorinating, drying operations at high temperatures which generates HCl which cause corrosion and also forms corresponding rare earth metal oxychlorides as an impurity which reduces the efficiency of anhydrous rare earth metal halide as a catalyst for organic reactions, drying agents which cause corrosion thereby reducing the maintenance; low temperature process accordingly energy consumption is less. The present invention is efficient, environment friendly, faster, and economical on large scale.

### OBJECT OF INVENTION

It is an object of the present invention to provide a novel process for the preparation of anhydrous rare earth metal halides particularly chlorides comprising preparing slurry of rare earth metal halide hydrate in an organic solvent, refluxing and azeotropic distillation for quantitative removal of surface and bonded water.

A further object of the present invention is to provide a novel process for dehydration of anhydrous cerium (III) chloride and lanthanum chloride comprising preparing slurry of respective heptahydrate in an aromatic hydrocarbon, refluxing and azeotropic distillation for quantitative removal of surface and bonded water.

A further object of the present invention is to provide a process for the preparation of anhydrous cerium (III) chloride and lanthanum chloride with water content up to 1.0%.

A further object of the present invention is to provide a process for the preparation of anhydrous cerium (III) chloride free or undetectable traces, if present, of CeOCl.

A further object of the present invention is to provide a process for of the preparation of anhydrous cerium (III) chloride that can be used in combination with organometallics to be added to carbonyl group.

A further object of the present invention is to provide a process for of the preparation of anhydrous lanthanum chloride that can be used in combination with hexamethyldisilazane for the purpose of silylation.

A further object of the present invention is to provide a process for the preparation of anhydrous lanthanum chloride free or having undetectable low content of LaOCl.

### SUMMARY OF INVENTION

Disclosed herein is a novel process for preparing anhydrous rare earth metal halides comprising the slurring and refluxing respective rare earth metal halide hydrates in an organic hydrocarbon with simultaneous quantitative removal of surface and bonded water.

### DETAILED DESCRIPTION OF THE PRESENT INVENTION

Rare earth metal halides generally occur in nature in hydrated form. Rare earth metal halides being hygroscopic absorb water on exposure to atmosphere to form corresponding hydrates. The hydrated form of the rare earth metal halide makes it unsuitable for use in chemical processes like production of metals, as a catalyst in addition reaction of organometallics to carbonyl compounds to form corresponding alcohol and the like. The present invention discloses a novel and efficient process for the preparation of anhydrous rare earth metal.

The expression “Rare earths” employed in accordance with the invention hereinbefore and hereinafter includes the rare earth elements called lanthanides having atomic numbers from 57-71 and also inclusive of yttrium of atomic number 39. The rare earth metal halides are halides of lanthanum, neodymium, cerium, and praseodymium, yttrium, and gadolinium. Preferably rare earth metal halides are halides of cerium and lanthanum. More preferably rare earth metal halide is cerium (III) chloride.

The hydrated rare earth metal halide to be dehydrated is preferably introduced into the reactor having Dean-Stark provision so that water can be removed along with solvent by the concept of Binary composition/mixture that boils at a constant temperature i.e. the water from the hydrate is removed azeotropically. Rare earth metal halide hydrate is well slurred and refluxed in an organic solvent. The organic solvent is selected from an aromatic hydrocarbon. Preferably the organic hydrocarbon is selected from toluene, xylene and the like. More preferably the organic solvent is xylene. Water is removed azeotropically from the slurry is separated. The said product is collected by filtration, dried and packed under inert atmosphere.

Invention discloses the conversion of (S)-hydroxy esters into corresponding tertiary alcohol. An embodiment describes the preparation of [3-[(1E)-2-(7-chloro-2-quinolinyl)ethenyl]phenyl]-3-[2-propanol] hereinafter referred as “diol”. The said diol is an important intermediate for the preparation of montelukast.

The invention is further illustrated by the examples given below:

### Example 1

Dehydration of CeCl₃ heptahydrate:

To a 3 lt/4 neck round bottom flask fitted with a mechanical stirrer, reflux condenser, Dean and Stark apparatus and calcium chloride drying tube was charged solvent like toluene or xylene (2.2 lit) and cerium chloride heptahydrate (558 g, 1.5 mol) and the slurry was heated to reflux with simultaneous azeotropic water removal. Water removal was continued till almost quantitative water distilled out (187-189 ml) which took almost 48 hrs, resulted in 1.2% moisture content.

The reaction mass slurry was then cooled to 25 to 30° C. and crystalline solids were filtered and washed with respective solvent (toluene or xylene) under nitrogen blanket. Moisture content of the solid was checked and was found to be in the range of 0.5-1.0%. The cake was preserved under nitrogen atmosphere and activation of CeCl₃ is done before use.

Application of the invention w.r.t. use of CeCl₃ with organometalics: The effect of moisture content of the cerium chloride in a reaction of a carbonyl compound as shown below is studied and depicted below:

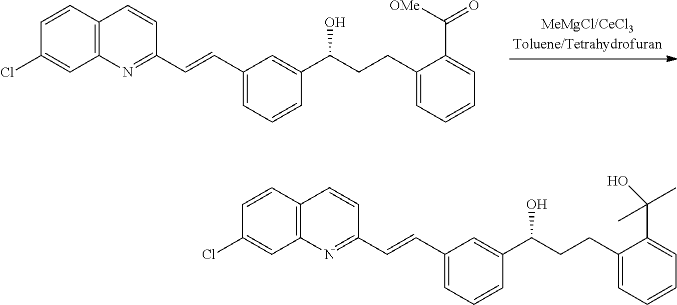

### Example 2

28.0 g cerium chloride having moisture content of 0.7% stocked under inert atmosphere after azeotropic drying is further activated by refluxing in THF 150 ml for three hours was cooled to −5° C. 81.8 gm methyl magnesium chloride dissolved in 360 ml THF was added in about half an hour keeping the temperature at −5° C. Stirring is continued for 15 minutes. Contents were added with solution of 100 g hydroxy ester dissolved in 200 ml toluene keeping the temperature at −5° C. in 45-50 minutes. Reaction is monitored on HPLC. After the 1.5 hrs reaction mass was observed to contain 1.5% unreacted hydroxyl ester, 3.3% keto impurity and 95.5% of required diol, was taken for work up by the process as available in the art yielded 94.0 g required diol which is taken for further purification.

Purification: 94.0 g Crude diol is taken into 23S ml toluene and the contents were heated till 60° C. to get a clear solution. 470 ml water was then added at 60° C., cooled gradually to bring down room temperature. Stirring was continued for overnight. Contents were cooled to 5-8° C. and maintained for 2 hrs for the complete precipitation. Product was filtered of and suck dried. Material was removed and vacuum dried to get 77.0 g diol with 98.5% HPLC purity.

### Example 3

Dehydration of LaCl₃ heptahydrate: To a 3 lt/4 neck round bottom flask fitted with a mechanical stirrer, reflux condenser, Dean and Stark apparatus and calcium chloride drying tube was charged solvent like toluene or xylene (80 ml) and cerium chloride heptahydrate (20 g, moisture content 34.2%) and the slurry was heated o reflux with simultaneous azeotropic water removal. Water removal was continued till almost quantitative water distilled out (6.8 ml) which took almost 12 hrs, resulted in 8.6% moisture content which on further continuation resulted into 2.5-1.9% moisture content.

The reaction mass slurry was then cooled to 25 to 30° C. and crystalline solids were filtered and washed with respective solvent (toluene or xylene) under Nitrogen blanket. Moisture content of the solid was checked and was found to be in the range of 1.7%. The cake was preserved under nitrogen atmosphere.

1. A process of preparing anhydrous rare earth metal halides comprising:
a) Forming a slurry of rare earth metal halide hydrate in an organic solvent
b) Refluxing the said slurry;
c) Distillation of water from the said slurry.

2. Process of claim 1 wherein rare earth metal halide is selected from cerium (III) chloride and lanthanum chloride.

3. A process of claim 1 wherein rare-earth metal halide hydrate is cerium (III) chloride heptahydrate and lanthanum chloride heptahydrate.

4. Process of claim 1 wherein an organic solvent is selected from aromatic hydrocarbon.

5. The process of claim 4 wherein aromatic hydrocarbon is selected from toluene or xylene.
